(19) United States
(12) Patent Application Publication
(10) Pub. No.: US 2026/0122172 A1
(43) Pub. Date: Apr. 30, 2026

(54) DISPLAYING SECURE INFORMATION BASED ON EMERGENCY CONDITION DETECTION

(71) Applicant: MOTOROLA MOBILITY LLC, WILMINGTON, DE (US)

(72) Inventor: AMIT KUMAR AGRAWAL, BANGALORE (IN)

(21) Appl. No.: 18/931,402

(22) Filed: Oct. 30, 2024

(51) Int. Cl. H04M 1/72421; G06Q 40/08; G06Q 50/26; H04M 1/72409; H04M 1/72457

(52) U.S. Cl. CPC H04M 1/72421; G06Q 40/08; G06Q 50/265; H04M 1/724098; H04M 1/72457

(57) ABSTRACT

A method provides techniques for detecting, on an electronic device comprising a display, an emergency condition based on received trigger data. In response to detecting the emergency condition, emergency information that is securely stored on the electronic device is accessed. The emergency information is rendered and presented on the display of the electronic device, thereby providing first responders to an emergency with important information for providing immediate care to a victim of an emergency condition and/or contacting emergency contacts to alert them of the emergency.

### BACKGROUND

### 1. Technical Field

The present disclosure generally relates to electronic devices, and more specifically to emergency detection actions of electronic devices.

### 2. Description of the Related Art

Smartphones are frequently used to store a wide range of essential data, covering both personal and practical aspects of a user's life. Smartphones, along with other mobile devices, can often contain contact information, such as telephone numbers, email addresses, social media profiles, and other details related to friends, family, and colleagues. As smartphones have become integral to everyday activities, some of the data they hold is often highly sensitive. This data may include names, addresses, dates of birth, and scanned copies of identification or other important documents. The growing reliance on smartphones has also accelerated the shift from physical documents, such as driver's licenses and insurance cards, to digital versions stored on mobile devices, marking a key milestone in the evolution of digital identity management. This transition is driven by factors such as convenience, enhanced security, and technological progress. Governments, insurance companies, and individuals are increasingly adopting digital identification and documents, and this trend is expected to continue as technology advances.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to display secure information based on emergency condition detection, according to one or more embodiments;

FIG. 2A illustrates an example scenario in which first secure information is displayed based on emergency condition detection at a first location, according to one or more embodiments;

FIG. 2B illustrates an example scenario in which second secure information is displayed based on emergency condition detection at a second location, according to one or more embodiments;

FIG. 3 is an example of an emergency notification user interface presenting contact information, according to one or more embodiments;

FIG. 4 is an example of an emergency notification user interface presenting a health insurance e-card, according to one or more embodiments;

FIG. 5 is an example of an emergency notification user interface presenting medical information, according to one or more embodiments;

FIG. 6 is an example of an emergency detection response configuration user interface, according to one or more embodiments;

FIG. 7 depicts a flowchart of a computer-implemented method for display of secure information based on emergency condition detection, according to one or more embodiments; and

FIG. 8 depicts a flowchart of a computer-implemented method for rendering and presenting a contact list based on distance and availability, according to one or more embodiments.

### DETAILED DESCRIPTION

According to aspects of the present disclosure, an electronic device, a method, and a computer program product provide techniques for implementing display of secure information based on emergency condition detection, according to one or more embodiments. The secure information that is displayed is relevant for an emergency situation, such as medical information, insurance information, emergency contact person, and the like.

Emergency situations can arise unexpectedly, posing immediate risks to individuals' safety and well-being. These emergencies may involve accidents or medical crises, leaving individuals unconscious, critically injured, or even deceased. In such cases, when the person is admitted to a medical facility, family members may be asked to provide insurance information, identification, legal documents, and other essential records, such as a power-of-attorney or will. Many of these documents may be stored on or accessible through the individual's smartphone, which is often, by default, protected by multiple layers of security to unlock the device and/or access secure folders stored within the device. However, in the case of an emergency, some of this protected information can be essential for resolving an emergency situation. For a first responder arriving at the scene of an emergency, such as paramedics and police, quick access to important secure emergency information such as an emergency contact list, medical information, and/or insurance information, can be instrumental in expediting proper care for an individual experiencing an emergency situation.

The disclosed embodiments address the aforementioned issues by surfacing secure emergency information on an electronic device associated with a user in response to detecting an emergency. The secure emergency information can include contact information for one or more contacts, medical information, insurance information, and/or other important instructions and/or information for first responders and/or others that are providing aid to a user who is involved in an emergency.

According to one aspect, data received from one or more sensors are continuously or periodically monitored for trigger data indicative of an emergency condition. The sensors can include accelerometers, motion sensors, biometric sensors, among others. In response to detecting the trigger data that indicates an emergency condition, emergency information is rendered and presented on an electronic device. The emergency information can be rendered and presented on a display of the electronic device, regardless of a lock status of the electronic device. The emergency information can include a contact list, health insurance information, medical information, and/or other information that may be needed or useful to have as a result of an emergency such as a serious injury of the user.

In some embodiments, the emergency information that is rendered and presented can be based on an emergency context. The emergency context can include a location of the emergency, a location of electronic devices associated with one or more emergency contacts for the user, and/or other criteria. Upon detecting and/or determining an emergency condition, disclosed embodiments render and present secure emergency information based on an emergency context. As an example, when an emergency is detected/determined, a contact list including multiple contacts can be rendered and presented on a display of the electronic device associated with the user. The contact list can be dynamic, based on location/distance between the user's electronic device and the electronic devices associated with the one or more emergency contacts. In one or more embodiments, the contact list can be ranked, such that the emergency contacts that are determined to be closer to the user are listed first. In one or more embodiments, the electronic device of the user provides an option to contact an emergency contact directly from the electronic device of the user, thereby reducing the time required to communicate with an emergency contact. In one or more embodiments, the content rendered and presented on a display of the user's electronic device can automatically change based on the emergency context. As another example, if a user is being transported to a hospital, in response to the user's electronic device becoming within a predetermined distance of the hospital, insurance and/or other medical information such as a medication list, list of allergies, and/or medical conditions, can be rendered and presented on a display of the electronic device of the user. In this way, relevant information is presented as the emergency mitigation transitions from rescue to providing medical treatment.

One or more embodiments can provide an electronic device that includes: a display; a communications subsystem enabling the electronic device to communicatively connect to at least one second electronic device; a memory having stored thereon an emergency condition management (ECM) module; at least one processor coupled to the communications subsystem and the memory and which processes program code of the ECM module, the at least one processor configured to cause the electronic device to: detect an emergency condition based on trigger data received by the at least one processor; and in response to detecting the emergency condition: access emergency information that is securely stored on the electronic device; and render and present the emergency information on the display of the electronic device.

One or more embodiments can provide a method that includes: detecting, on an electronic device comprising a display, an emergency condition based on received trigger data; and in response to detecting the emergency condition: accessing emergency information that is securely stored on the electronic device; and rendering and presenting the emergency information on the display of the electronic device.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

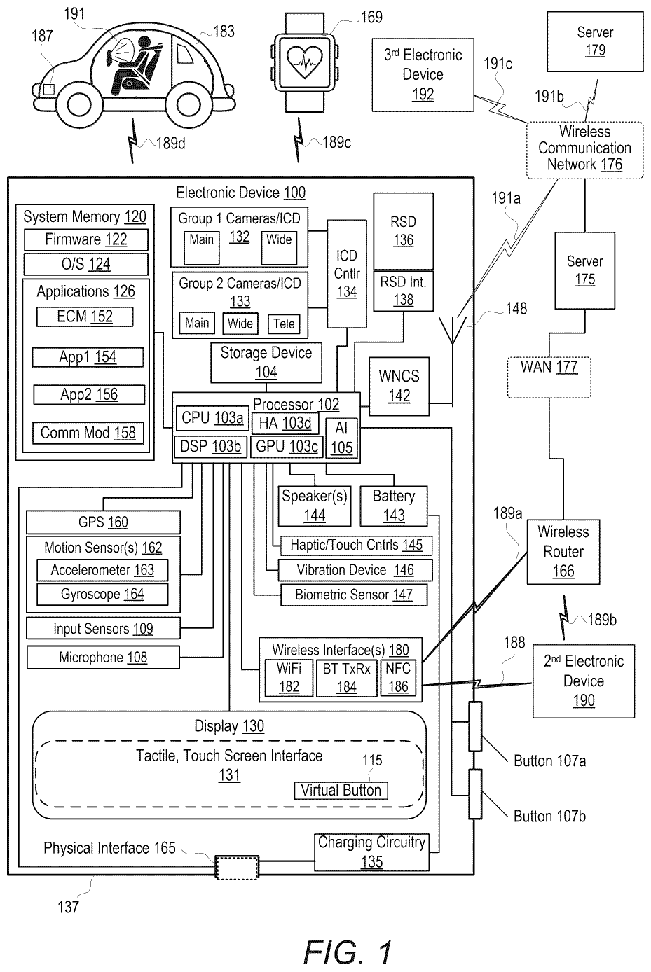

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can be and is interchangeably referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

For simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical and photographic images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, emergency condition management (ECM) module 152, other applications, indicated as App1 154 and App2 156, and communication module 158. Each module and/or application provides program instructions/code that are processed by processor 102 to configures/cause processor 102 and/or other components of electronic device 100 to perform specific operations, as described herein. Descriptive names assigned to these modules add no functionality and are provided solely to identify the underlying features performed by processing the different modules. For example, emergency condition management (ECM) module 152 can include program instructions for implementing features of the disclosed embodiments. The ECM module 152 can include instructions that cause or configure processor 102 to identify an emergency condition (or determine that an emergency condition exists based on received/sensed data), and in response, surface emergency information onto a display of electronic device 100. Other features are described in further detail throughout this disclosure.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. The term image capturing device (ICD) can be utilized interchangeably to be synonymous with and/or refer to any one of the cameras 132, 133. Both sets of cameras 132, 133 include image sensors that can capture images that are within the field of view (FOV) of each respective camera 132, 133. In one or more embodiments, ICDs 132, 133 can be utilized to enable biometric authentication using facial image or iris scan recognition.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications, such as a copy of ECM module 152, stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on integrated display 130. Tactile, touch screen interface 131 can be utilized as an input device. The touch screen interface 131 can include one or more virtual buttons, indicated generally as 115. In one or more embodiments, when a user applies a finger or stylus on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide for multiple integrated displays within electronic device 100 and references to integrated display 130 are assumed to refer to any one and/or all of these multiple integrated displays.

Electronic device 100 can further include one or more input buttons, indicated as 107a and 107b, microphone 108, input sensors 109 (e.g., sensors enabling gesture detection by a user), and one or more output devices, such as speakers 144. While two buttons are shown in FIG. 1, other embodiments may have more or fewer input buttons. Input buttons 107a and 107b may provide controls for volume, power, and ICDs 132, 133. Microphone 108 can also be referred to as an audio input device. In some embodiments, microphone 108 may be used for identifying a user via voiceprint, voice recognition, and/or other suitable techniques.

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera), which provides facial recognition for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless network communication subsystem (WNCS) 142, which can represent one or more front end devices (not shown) that are each coupled to one or more antennas 148. In one or more embodiments, WNCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, such as second electronic device 190 and/or third electronic device 192 via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with wireless communication network 176 via transmissions of communication signals 191a to and from network communication devices, such as base stations or cellular nodes, of wireless communication network 176. Wireless communication network 176 further allows electronic device 100 to wirelessly communicate with server 175, and other communication devices, such as third electronic device 192, which can be similarly connected to wireless communication network 176 via respective communication signals 191b and 191c. In one or more embodiments, second electronic device 190 and/or third electronic device 192, can be a communication device, such as a smartphone.

In one or more embodiments, electronic device 100 can communicate wirelessly with external wireless devices, such as a WiFi router 166 or second electronic device 190, via one or more of short-range wireless interface(s) 180. In one or more embodiments, WiFi router 166 may be connected to a WAN 177 and/or server 175. Server 175 may also be connected to wireless communication network 176, which may enable connection to other servers, such as server 179 via communication signal 189c. Electronic device 100 can wirelessly communicate with second electronic device 190 via communication signal 188 (communicating between wireless interface(s) 180 and second electronic device 190). Communication signal 189a and communication signal 189b provide a communication path from electronic device 100 to second electronic device 190. In one or more embodiments, signals 188 and/or signals 189a may be transmitted by short range communication device(s) within wireless interface(s) 180. In one or more embodiments, a wearable computing device 169, such as a smartwatch, fitness tracker, or the like, may be paired with electronic device 100, and provide biometric data such as heart rate, breathing rate, and the like, to the electronic device 100. Communication signal 189c may be used to enable communication between electronic device 100 and wearable computing device 169. Wireless interface(s) 180 can include short-range wireless communication adapters/transceivers, such as wireless fidelity (Wi-Fi) transceiver 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, WNCS 142 with antenna(s) 148 and wireless interface(s) 180 collectively provide/represent the wireless communications subsystem of electronic device 100.

In one or more embodiments, electronic device 100 may communicate with an in-vehicle computer 187 of a vehicle 183. In one or more embodiments, the communication signal 189d may include a Bluetooth signal, or other near field communication signal to enable information regarding the vehicle 183 to be communicated from the in-vehicle computer 187 to the electronic device 100. The information can include event information, such as indicating deployment of an airbag 191, which can be indicative of a collision, and thus, a potential emergency condition. Electronic device 100 of FIG. 1 is only a specific example of a device that can be used to implement the embodiments of the present disclosure.

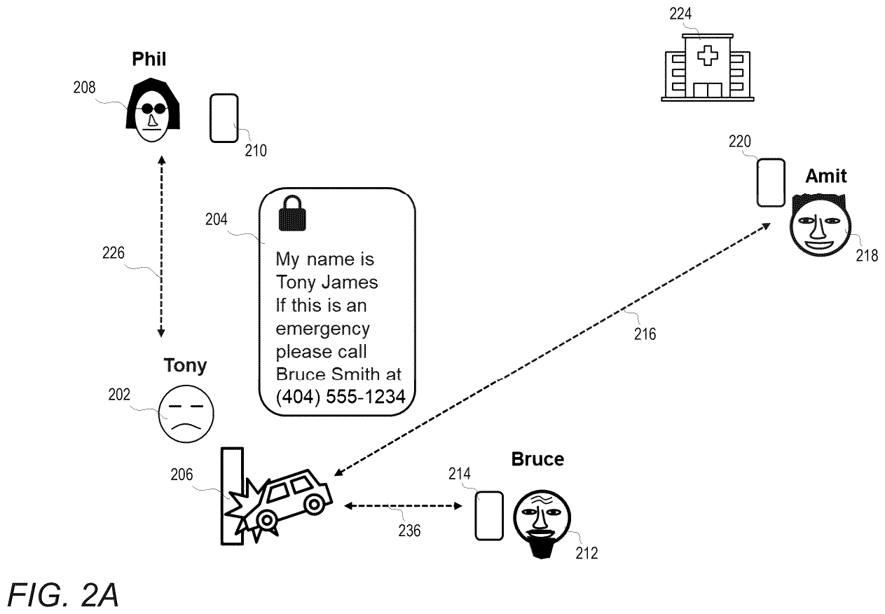

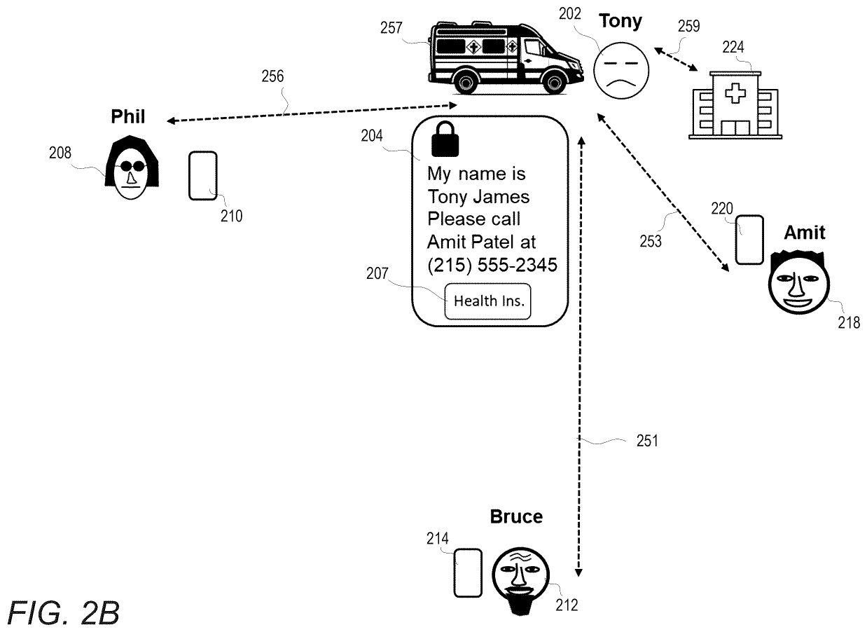

FIG. 2A illustrates an example scenario in which first secure information is displayed based on emergency condition detection at a first location, according to one or more embodiments. The example of FIG. 2A shows four individuals, each having (i.e., being a user of) a separate communication device. The electronic devices 204, 210, 214, and 220 may be similar to electronic device 100 shown in FIG. 1. First person (Tony) 202 has associated electronic device 204, which is configured with ECM 152 and is monitoring for emergency conditions. Second person (Phil) 208 has associated electronic device 210. Third person (Bruce) 212 has associated electronic device 214. Fourth person (Amit) 218 has associated electronic device 220. In the example of FIG. 2A, Tony 202 is involved in a vehicle accident, indicated at 206. In one or more embodiments, an emergency condition/situation is detected based on trigger data. For the scenario of a vehicle accident, the trigger data can come from accelerometer data provided by an accelerometer within the electronic device 204 associated with Tony 202 (e.g., 163 of FIG. 1). Additionally, or alternatively, one or more embodiments may involve the electronic device 204 being communicatively connected to an in-vehicle computer and obtaining trigger data from the in-vehicle computer (e.g., 187 of FIG. 1). In one or more embodiments, the trigger data can include deployment of an airbag (e.g., 191 of FIG. 1). Other types of trigger data or emergency conditions, detected by the in-vehicle computer 187 and/or the electronic device 204, are supported.

In one or more embodiments, one or more emergency contacts may be established a priori. In the example of FIG. 2A, Tony 202 has previously established three emergency contacts: Phil 208), Bruce 212) and Amit 218). In one or more embodiments, a distance between the electronic device 204 that detected an emergency condition, and each of the corresponding emergency contact electronic devices (210, 214, and 220), is determined. The distance between electronic device 204 and each of electronic device 210, electronic device 214, and electronic device 220 is indicated respectively via distance arrow 226, 236, and 216. It is appreciated that the distance measurement used can be the travel distance between the two devices based on the current time and travel conditions, and not the linear distance between the devices based on geographic separation. In one or more embodiments, electronic devices 210, 214, and 220 may share location data with electronic device 204. In one or more embodiments, electronic devices 210, 214, and 220 may update location data (e.g., from a geolocation receiver, and/or other location information sources) to a server (e.g., server 175 of FIG. 1), and the location data may be periodically retrieved by electronic device 204. In one or more embodiments, such as when the devices are registered in a monitored (family or friend) group, the location data is retrieved at an interval ranging from every 60 seconds to every 120 seconds. In one or more embodiments, each electronic device may retrieve a current longitude and latitude via an onboard geolocation receiver (e.g., 160 of FIG. 1). In some embodiments, the geolocation receiver accuracy is further enhanced via WiFi and/or cellular tower triangulation techniques. In some embodiments, each electronic device associated with an emergency contact may encode the location coordinates, along with a timestamp, into a message, such as a JSON or HTTP request that is received by electronic device 204. Other retrieval intervals are possible in disclosed embodiments. In some embodiments, the retrieval of the location data may be triggered as a device response to detecting the emergency condition.

Based on the location reported by electronic devices 210, 214, and 220, the corresponding distances from electronic device 204 can be determined, and sorted based on shortest distance. In the example of FIG. 2A, the distance 236 is shorter than distance 226 and distance 216. As previously mentioned, the illustrated distances can be representative of the travel distance. Accordingly, contact information associated with electronic device 214 is rendered and presented on electronic device 204 that is associated with Tony 202. Since Tony 202 is involved in an emergency (vehicle accident 206), his electronic device presents contact information for electronic device 214, corresponding to Bruce 212. Accordingly, the emergency information rendered and presented on electronic device 204 includes the name of the device user and instructs a person looking at the device to call Bruce, and provides contact information for Bruce 212, since Bruce is determined to be the closest to the location of the emergency situation. In this way, first responders arriving at the scene of vehicle accident 206 can immediately obtain an identification of the user involved in the accident (Tony James), as well as contact information for an emergency contact (Bruce Smith, (404) 555-1234).

FIG. 2B illustrates an example scenario in which second secure information is displayed based on emergency condition detection at a second location, according to one or more embodiments. As part of an emergency response, Tony 202 may later be transported to medical facility 224. According to one embodiment, AI engine (105, FIG. 1) of electronic device can determine to some certainty, based on evaluating the emergency conditions and/or using always-on technology to monitor conversations and images around the device, that the device is being transported towards a hospital or medical facility. Continuing from the example shown in FIG. 2A, the Tony 202 is being transported by ambulance 257 to medical facility 224. In one or more embodiments, the electronic device 204 monitors its geographic location relative to a navigation map of the area, and upon detecting/determining that the electronic device 204 is moving from its original location and/or is within a predetermined distance of medical facility 224, electronic device 204 automatically updates the surfaced secure emergency contact information. Based on the new location of electronic device 204 shown in FIG. 2B, the distances (or travel distances) between electronic device 204 and electronic device 210 electronic device 214, and electronic device 220, indicated via directional arrows 256, 251, and 253, has changed. Thus, as shown in FIG. 2B, the distance indicated at 253 is the shortest distance amongst the distances 253, 251, and 256. Accordingly, the contact information associated with electronic device 220, belonging to Amit 218 is rendered and presented on a display of electronic device 204 in place of or in addition to the original contact information associated with electronic device 214 (FIG. 2B). In addition, since the electronic device 204 is within a predetermined distance (e.g., 2 kilometers) of the medical facility 224, a health insurance e-card option 207 is rendered and presented on a display of electronic device 204. The health insurance e-card option 207, when invoked, can present health insurance information, such as a health insurance account number, and/or other pertinent information for admittance of Tony 202 into medical facility 224. Thus, disclosed embodiments can dynamically update emergency information that is surfaced based on emergency context, where the emergency context can include a detected/determined distance between an emergency contact, a detected/determined distance between a user electronic device and a medical facility, and/or other relevant criteria.

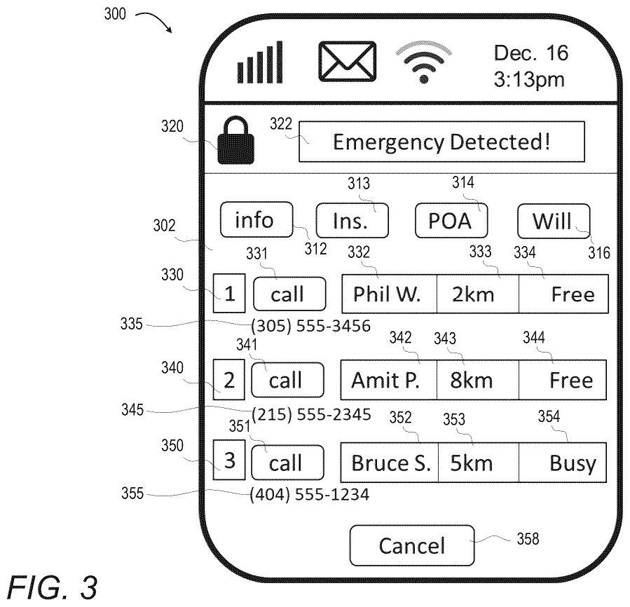

FIG. 3 is an example of an emergency notification user interface presenting contextual contact information, according to one or more embodiments. Device 300 may be similar to electronic device 100 depicted in FIG. 1. Device 300 includes display 302. The emergency notification user interface rendered and presented on the display 302 of device 300 can include an emergency detected notification text field 322. The emergency notification user interface presenting contact information can be displayed even when the device is locked, as indicated by lock icon 320. In one or more embodiments, if an emergency condition is detected while the electronic device 300 is in an unlocked state, the electronic device 300 automatically locks. In this way, first responders and/or others that arrive at the emergency scene have limited access to the electronic device 300, and can only view contents of, and/or interact with, the electronic device 300 as permitted by the emergency notification user interface.

The emergency notification user interface of FIG. 3 includes three emergency contacts, indicated at 330, 340, and 350. Contact 330 is presented first in a sorted list of contacts, based on a relative distance 333 to electronic device 300 and an availability status 334. Contact name 332 is the name of the person corresponding to contact 330. The contact information (e.g., phone number) for contact 330 is shown in contact information field 335. One or more embodiments may further include a call option 331 that permits a voice call to be placed from electronic device 300 to the telephone number indicated in contact information field 335. By allowing calls to be placed from the electronic device 300 (belonging to the person involved in the emergency) to the emergency contacts, the likelihood that the emergency contact may answer the call may increase, as many users do not answer calls from unrecognized telephone numbers. Thus, by allowing calls to emergency contacts from electronic device 300, the recipient may be more likely to answer the incoming voice call, as they will likely recognize the source of the incoming voice call.

Continuing with the example shown in FIG. 3, the second contact 340 has a distance 343, availability status 344, name 342, contact information field 345, and corresponding call option 341. Similarly, the third contact 350 has a distance 353, availability status 354, name 352, contact information field 355, and corresponding call option 351. In one or more embodiments, availability status for a given contact may be established by retrieving information from a shared calendar for that contact. In other embodiments, the availability status may be manually set by a user a priori. For example, if it is known that a particular contact is never available on a certain day of the week, that contact can be indicated as unavailable (busy) during that day of the week. Thus, the user of electronic device 300 can pre-configure which emergency contacts to present based on identified factors, such as, the type of emergency, the time and/or location of the emergency, etc.

Referring to emergency contact 350, the user is indicated as ‘Busy’ based on availability status 354. Emergency contact 340 is indicated as free/available. Contact 350 is detected/determined to be 5 km away from electronic device 300 (based on distance 353), and contact 340 is detected/determined to be further away than contact 350, at 8 km away from electronic device 300 (based on distance 343). Even though contact 350 is detected/determined to be closer to electronic device 300 than contact 340, contact 340 is ranked higher in the sorted list of emergency contacts, based on the availability status. Thus, one or more embodiments can consider both availability status and distance in ranking contacts in a sorted list of emergency contacts that are rendered and presented on display 302 of electronic device 300. In one or more embodiments, contacts that are indicated as free (available) are ranked higher than contacts that are indicated as busy (unavailable). It is appreciated that the status of each user (free/busy) does not need to be surfaced on device display, as that detail is primarily used by the processor or AI engine in evaluating the order for presentation of the contact.

In one or more embodiments, the emergency notification user interface of FIG. 3 may further include additional information that can be invoked via options. Option 312 when invoked, can cause additional information, such as a name, address, list of medications, list of medical conditions, hospital preferences, list of allergies, and/or other relevant information to be rendered and presented on display 302 of electronic device 300. Option 313, when invoked, can cause insurance information to be rendered and presented on display 302 of electronic device 300. Option 314, when invoked, can cause power of attorney (POA) information to be rendered and presented on display 302 of electronic device 300. Option 316, when invoked, can cause will information to be rendered and presented on display 302 of electronic device 300. Option 358, when invoked, may enable a user to cancel the emergency notification user interface. In one or more embodiments, when option 358 is invoked, the electronic device 300 renders and presents an authentication challenge for a user to enter biometric and/or non-biometric authentication in order to cancel the emergency notification user interface. The cancel option 358 can be useful for ‘false alarm’ situations, such as in a case where a user drops his/her electronic device, causing an onboard accelerometer to output trigger data that is incorrectly interpreted as an emergency condition. Instead of, or in addition to, the options shown in the emergency notification user interface of FIG. 3, other options may be provided in one or more embodiments, including, but not limited to, providing power-of-attorney documents, living wills, and/or other relevant information. One or more embodiments can include: determining an availability status of a respective user of each of the one or more second electronic devices; sorting the contact information corresponding to each of the one or more second electronic devices based on the corresponding determined availability status of the respective user; and selectively rendering and presenting, on the display of the electronic device, the contact information corresponding to at least one of the one or more second electronic devices whose user is determined to be currently available.

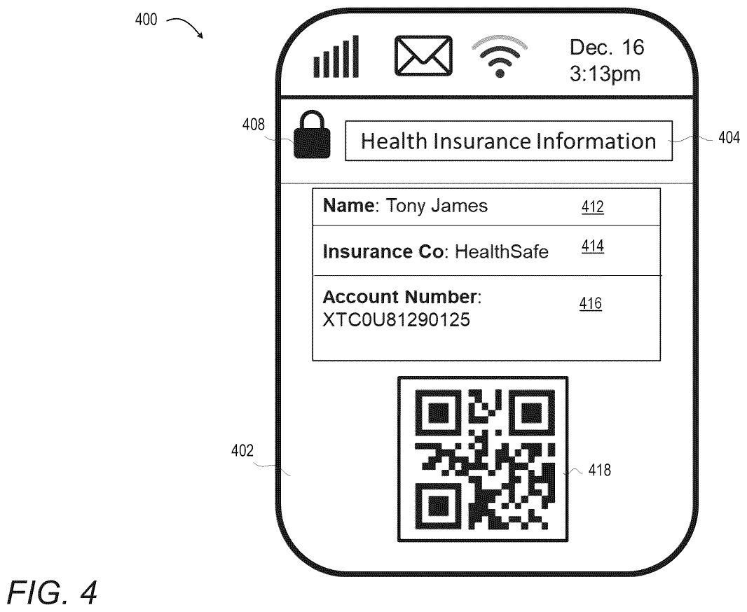

FIG. 4 is an example of an emergency notification user interface presenting a health insurance e-card, according to one or more embodiments. Device 400 may be similar to electronic device 100 depicted in FIG. 1. Device 400 includes display 402. In one or more embodiments, the emergency notification user interface presenting a health insurance e-card can be rendered and presented in response to invoking health insurance e-card option 207 of FIG. 2B. One or more embodiments can include: in response to determining that a distance between the electronic device and a medical facility is less than a predetermined distance, rendering and presenting, on the display of the electronic device, a health insurance e-card comprising at least one of an account holder name, an insurance provider, and an account number. The presented health insurance e-card can include a health insurance information text field 404. The presented health insurance c-card can be rendered and presented on display 402 of electronic device 400, even when the electronic device 400 is in a locked state, as indicated by lock icon 408. The presented health insurance e-card can include a text field 412 for a user name, a text field 414 indicating an insurance company name, and a text field 416 indicating an account number (or alphanumeric identifier) corresponding to the user name indicated in text field 412. In one or more embodiments, the presented health insurance e-card can further include an optically encoded identifier 418, such as a QR code, barcode, or the like, that encodes the information in one or more of the text fields 412, 414, and 416, to enable convenient scanning and upload of the health insurance information.

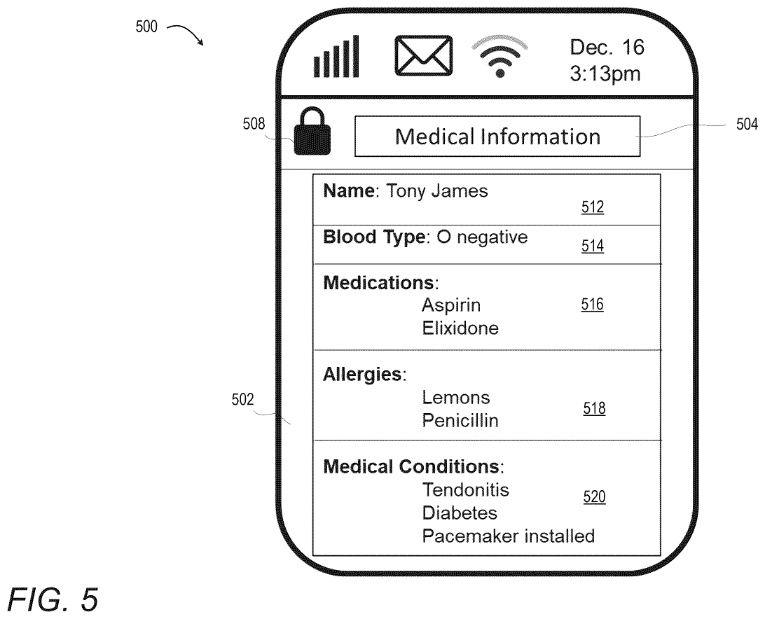

FIG. 5 is an example of an emergency notification user interface presenting medical information, according to one or more embodiments. Device 500 may be similar to electronic device 100 depicted in FIG. 1. Device 500 includes display 502. In one or more embodiments, the emergency notification user interface presenting a medical condition list can include a medical information text field 504. The emergency notification user interface presenting medical information can be rendered and presented on display 502 of electronic device 500, even when the electronic device 500 is in a locked state, as indicated by lock icon 508. The medical information shown in FIG. 5 can serve as a medical information e-card, and can include a text field 512 for an account holder (user) name, a text field 514 for a blood type, a text field 516 including a list of medications currently being taken by the user indicated at text field 512, a text field 518 indicating a list of allergies corresponding to the user indicated at text field 512, and a text field 520 indicating a medical condition list corresponding to the user indicated at text field 512. Other medical information may be shown instead of, or in addition to, the information shown in FIG. 5, in one or more embodiments. In one or more embodiments, the rendering and presenting of the emergency information on the display of the electronic device further comprises displaying a medical information e-card comprising at least one of a name, a blood type, a medication list, an allergy list, and a medical condition list. In one or more embodiments, a user enters (or scans in or captures and image of) the medical information shown in FIG. 5 as part of an initial configuration or setup process.

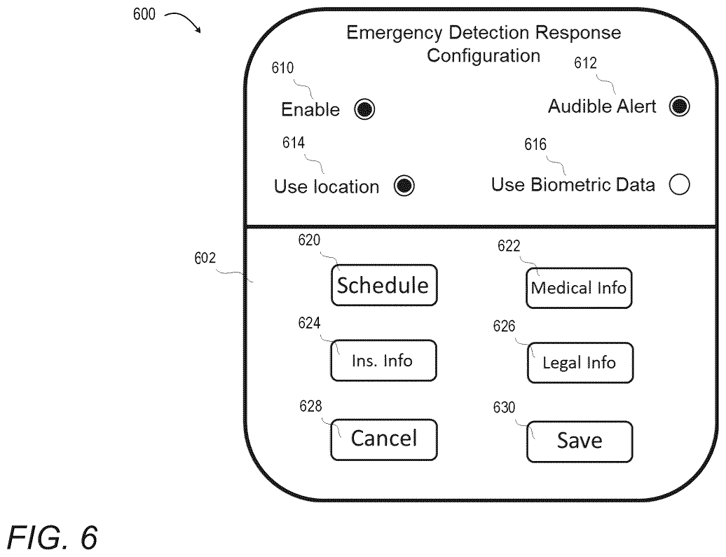

FIG. 6 is an example of an emergency detection response configuration user interface, according to one or more embodiments. Device 600 may be similar to electronic device 100 depicted in FIG. 1. Device 600 includes display 602. In one or more embodiments, the emergency detection response configuration user interface provides option 610 to enable or disable the overall feature. One or more embodiments may provide additional options. In the example of FIG. 6, the configuration user interface provides option 612 to enable an audible alert. When option 612 is selected, as shown in FIG. 6, the electronic device is configured to emit a periodic sound, such as a beep or tone, in response to determining/detecting an emergency condition. The periodic sound can aide a first responder in finding the electronic device at the scene of an emergency. In one or more embodiments, the configuration user interface provides option 614 to enable the use of location services. As shown in FIG. 6, this option is selected. When option 614 is selected, location information may be used as a criterion in determining/detecting an emergency context, and/or determining what information is shown on the display in response to detecting an emergency condition. In one or more embodiments, the configuration user interface provides option 616 to enable the use of biometric data, such as biometric data from on-device sensors (e.g., sensor 147 of FIG. 1) and/or sensors from external devices (e.g., 169 of FIG. 1). As shown in FIG. 6, option 616 is not selected. When option 616 is selected, biometric data, such as heart rate, breathing rate, and/or other biometric data obtained from the sensors may be used in determining/detecting an emergency condition, and/or determining a type of emergency and/or severity of an emergency.

The emergency detection response configuration user interface may further include additional configuration options. In the example of FIG. 6, the emergency detection response configuration user interface provides option 620 to enable establishing a schedule for determining contact information to display in response to detecting/determining an emergency condition. As an example, a user may configure the schedule such that between the hours of 8:00 am and 6:00 pm, his brother's contact information is displayed in response to detecting/determining an emergency condition, and outside of those hours, his sister's contact information is displayed in response to detecting/determining an emergency condition. The emergency detection response configuration user interface may further provide option 622 to enable entering medical information. The medical information can include medical conditions, such as diabetes, if a pacemaker is in use, etc. The medical information can further include a list of medications the user is currently taking, list of allergies, and/or other relevant information. The emergency detection response configuration user interface may further provide option 624 to enable entering insurance information. The insurance information can include insurance company name, policy numbers, coverage levels, and/or other relevant information. The emergency detection response configuration user interface may further provide option 626 to enable entering legal information. The legal information can include a will, living will, power-of-attorney, and/or other relevant information. The emergency detection response configuration user interface may further provide option 628 to cancel any unsaved changes and exit the emergency detection response configuration user interface. Conversely, the emergency detection response configuration user interface may further provide option 630 to save any unsaved changes and exit the emergency detection response configuration user interface.

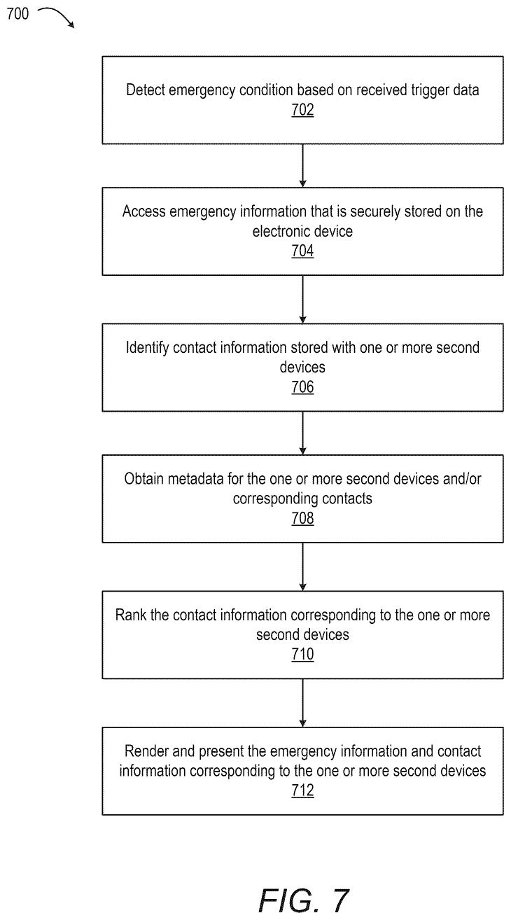

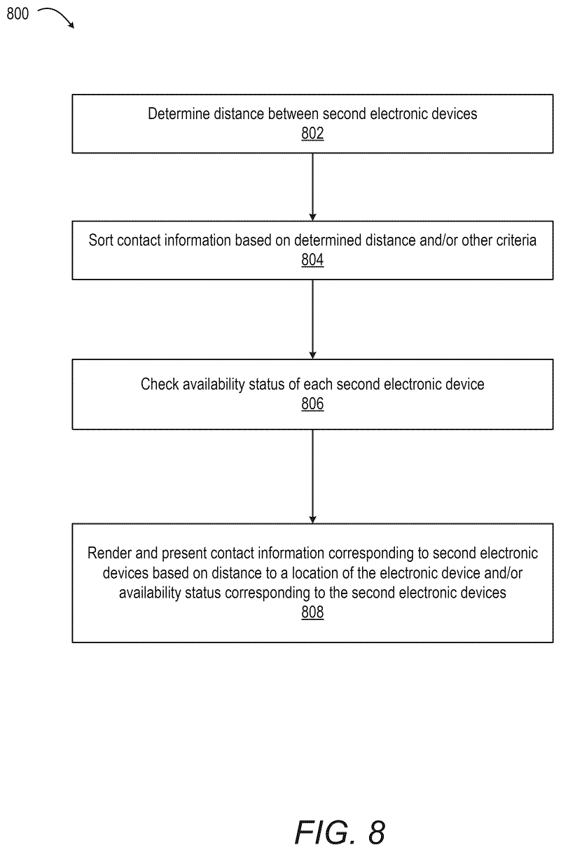

Referring now to the flowcharts presented by FIG. 7-FIG. 8, the descriptions of the methods in FIG. 7-FIG. 8 are provided with general reference to the specific components and features illustrated within the preceding FIGS. 1-6. Specific components referenced in the methods of FIG. 7-FIG. 8 may be identical or similar to components of the same name used in describing preceding FIGS. 1-6. In one or more embodiments, processor 102 (FIG. 1) configures electronic device 100 (FIG. 1) to provide the described functionality of the methods of FIG. 7-FIG. 8 by executing program code for one or more modules or applications provided within system memory 120 of electronic device 100, including emergency condition management (ECM) module 152.

FIG. 7 depicts a flowchart of a computer-implemented method for display of secure information based on emergency condition detection, according to one or more embodiments. The method 700 starts at block 702, where an emergency condition is detected/determined based on received trigger data. In one or more embodiments, the trigger data can be obtained from a sensor within the electronic device of a user (e.g., device 100 of FIG. 1), such as an accelerometer, motion sensor, microphone, and/or biometric sensor. One or more embodiments can include an accelerometer communicatively coupled to the at least one processor, where to detect an emergency condition, the at least one processor receives trigger data from the accelerometer that indicates an occurrence of an acceleration/deceleration incident affecting at least one of the electronic device and the established user and that is pre-established as one emergency condition. As an example, a sudden fall can cause an abrupt change in acceleration that is detectable by an accelerometer. Accordingly, an acceleration signal that indicates a fall has potentially occurred can be used as trigger data corresponding to an emergency condition.

In one or more embodiments, the trigger data can include trigger data received from an in-vehicle computer. As an example, the trigger data can include an accident indication that can be based on a sudden deceleration event, an airbag deployment event, hard braking, rapid steering, and/or other relevant events. In one or more embodiments, an airbag deployment event serves as trigger data corresponding to an emergency condition. In one or more embodiments, detecting the emergency condition comprises receiving an accident indication from an in-vehicle computer.

In one or more embodiments, the trigger data can include trigger data received from a biometric sensor. The trigger data can be obtained from a biometric sensor that is located within the electronic device (e.g., 147 of FIG. 1). In one or more embodiments, detecting the emergency condition comprises receiving biometric data from a biometric sensor within the electronic device that is pre-established as trigger data corresponding to one emergency condition. In one or more embodiments, the trigger data can be obtained from an external device, such as a wearable electronic device (e.g., 169 of FIG. 1). One or more embodiments can include detecting the emergency condition by receiving biometric data from a biometric sensor external to the electronic device that is pre-established as trigger data corresponding to one emergency condition. The biometric sensors can provide signals indicative of heart rate, breathing rate, and/or other biometric information. As an example, trigger data received from a biometric sensor that indicates no heart rate can be used to determine a cardiac arrest emergency condition. Thus, in embodiments, the biometric trigger data that is received by an electronic device is correlated to an emergency condition.

The method 700 continues to block 704, where emergency information that is securely stored on the electronic device is accessed. In one or more embodiments, the emergency information, such as name, address, date of birth, medical information, health insurance information, and the like, is stored in a secure filesystem within the electronic device of a user. The secure filesystem serves to provide strong protection for stored data through encryption, access controls, and other security measures. The secure filesystem enables the safeguarding of sensitive information such as cryptographic keys, personal data, and system configurations from unauthorized access, tampering, and data leakage. In one or more embodiments, files and data stored on the filesystem are encrypted using strong cryptographic algorithms (e.g., AES, RSA, and/or the like). The benefit of the secure filesystem is that the encryption used with the secure filesystem ensures that even if the physical storage medium is compromised (e.g., the device is lost or stolen), the data remains inaccessible without the appropriate decryption keys. A secure filesystem encrypts sensitive data, ensuring that only authorized entities can access it. The encryption is particularly important for devices handling personal, financial, or medical data, as described in disclosed embodiments.

The method 700 continues to block 706 where contact information associated with one or more second devices is identified. In one or more embodiments, one or more contacts from a contact database stored within memory of an electronic device of a user are designated a priori as emergency contacts for that user. The contact database can include one or more contact records, where each record corresponds to a person, and one or more contact records may be designated as emergency contacts. One or more embodiments can include: identifying contact information associated with one or more second electronic devices, wherein the one or more second electronic devices are associated with a designated emergency contact record stored within the electronic device; and rendering and presenting, on the display of the electronic device, the contact information corresponding to at least one of the one or more second electronic devices. The method 700 continues to block 708, where metadata for each of the one or more second devices and/or corresponding contacts is obtained. The metadata can include a current location for each electronic device corresponding to an emergency contact. The metadata can include an availability status for a user corresponding to a second electronic device. Other metadata may be obtained in one or more embodiments. The method 700 continues to block 710, where the contact information corresponding to the one or more second devices is ranked. In one or more embodiments, the contact information corresponding to the one or more second devices can be ranked based on distance from the electronic device corresponding to a user for which an emergency condition has been detected/determined. In one or more embodiments, the contact information corresponding to the one or more second devices can be further ranked based on an availability status of an emergency contact. In one or more embodiments, the contact information corresponding to the one or more second devices can be further ranked based on a type of emergency (e.g., medical, vehicle accident, etc.). The method 700 continues to block 712, where the emergency information and contact information corresponding to the one or more second devices is rendered and presented on an electronic device. An example of rendering and presenting the emergency information and contact information corresponding to the one or more second devices is shown in at least FIG. 3. Thus, one or more embodiments can include: determining a distance between the electronic device and each of the at least one second electronic devices; sorting the contact information corresponding to each of the one or more second electronic devices based on the corresponding determined distance; and selectively rendering and presenting, on the display of the electronic device, the contact information corresponding to at least one of the one or more second electronic devices that is closest in distance to a location of the electronic device.

FIG. 8 depicts a flowchart of a computer-implemented method for rendering and presenting a contact list based on distance and availability, according to one or more embodiments. The method 800 starts at block 802, where a distance is determined between an electronic device and one or more second electronic devices. In one or more embodiments, the distance is determined based on a Haversine function that accepts as input, a longitude-latitude coordinate pair for the electronic device and a second electronic device. In one or more embodiments, a driving distance between an electronic device and a second electronic device is determined (using navigational application/functions), and used as criteria for ranking emergency contacts. In one or more embodiments, real-time traffic conditions may be used as an additional ranking criterion for ranking the emergency contacts. The real-time traffic conditions can impact the travel time required for a given emergency contact to arrive at the scene of an emergency. As an example, a first emergency contact can be determined to be 4 kilometers away, with little to no traffic, and second emergency contact can be determined to be 2 kilometers away, but in an area with heavy traffic and road congestion, such that the travel time for the first emergency contact is less than the travel time for the second emergency contact to reach the scene of the emergency. One or more embodiments may use travel time as an additional ranking criterion. In one or embodiments, the longitude and latitude information may be provided from each of the second electronic devices to a server (e.g. server 175 of FIG. 1), which computes a driving distance and a travel time to the electronic device based on real-time traffic conditions, and provides the distance and travel time to the electronic device. In one or more embodiments, the driving distance and travel time may be computed by an on-device navigation application. The method 800 continues to block 804, where the contact information is sorted (ranked) based on distance and/or other criteria. The other criteria can include travel time, distance via roads, and/or other criteria.

The method 800 continues to block 806, where an availability status is determined for each contact. In one or more embodiments, the availability status is determined based on information in a shared calendar. As an example, if a shared calendar corresponding to an emergency contact indicates that the emergency contact is busy, on vacation, or otherwise unavailable, the calendar information may be used to infer an availability status of busy/unavailable for that emergency contact. The method 800 continues to block 808, where contact information corresponding to second electronic devices is rendered and presented in a ranked/sorted manner, based on distance to a location of the electronic device and/or availability status corresponding to the second electronic devices.

As can now be appreciated, disclosed embodiments provide techniques for sharing secure emergency information in response to a user device detecting an emergency condition or determining that an emergency condition has occurred based on evaluating received trigger data. Disclosed embodiments provide features that include surfacing contextual secure account contents based on closest and/or available emergency contacts, and/or other location-based information, in response to detecting an emergency condition such as a heart attack or a vehicle collision. Emergency data, including user identification information, and contact information for one or more contacts is surfaced on a display of an electronic device associated with a user. The emergency information can be surfaced even when the electronic device is in a locked state. The emergency information that is surfaced can change dynamically based on emergency context information. The emergency context information can include a current distance of designated emergency contacts, an availability of emergency contacts, proximity to a medical facility, and/or other criteria.

Disclosed embodiments also enable a first responder to an emergency to obtain vital information about the person experiencing the emergency. The information can include a user's legal name, insurance information, medical information, emergency contact information, and/or other relevant information. Normally, the aforementioned information may be stored in a secure storage area, such as a secure filesystem, to safeguard the data. However, in the event of an emergency, disclosed embodiments can surface some or all of the aforementioned information to enable first responders to obtain important information about the victim of an emergency. Some information, such as a medical history, can be critical in an emergency situation. For example, an automated external defibrillator (AED) can be used on someone with a pacemaker, but precautions are necessary, such as placement of the AED pads. With disclosed embodiments, information such as the use of a pacemaker can be provided to first responders, thereby enabling the first responders to take necessary safety precautions. Thus, the health, medical, and other information provided by the disclosed embodiments can help expedite the administering of proper medical care, potentially reducing the risks of protracted recovery or even death.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a communications subsystem enabling the electronic device to communicatively connect to at least one second electronic device;
a memory having stored thereon an emergency condition management (ECM) module; and
at least one processor coupled to the communications subsystem and the memory and which processes program code of the ECM module, the at least one processor configured to cause the electronic device to:
detect an emergency condition based on trigger data received by the at least one processor; and
in response to detecting the emergency condition:
access emergency information that is securely stored on the electronic device; and
render and present the emergency information on the display of the electronic device.

2. The electronic device of claim 1, wherein to render and present emergency information on the display of the electronic device, the at least one processor is further configured to:
identify contact information associated with one or more second electronic devices, wherein the one or more second electronic devices are associated with a designated emergency contact record stored within the electronic device; and
render and present, on the display of the electronic device, the contact information corresponding to at least one of the one or more second electronic devices.

3. The electronic device of claim 2, wherein the at least one processor is further configured to:
determine a distance between the electronic device and each of the at least one second electronic devices;
sort the contact information corresponding to each of the one or more second electronic devices based on the corresponding determined distance; and
selectively render and present, on the display of the electronic device, the contact information corresponding to at least one of the one or more second electronic devices that is closest in distance to a location of the electronic device.

4. The electronic device of claim 2, wherein the at least one processor is further configured to:
determine an availability status of a respective user of each of the one or more second electronic devices;
sort the contact information corresponding to each of the one or more second electronic devices based on the corresponding determined availability status of the respective user; and
selectively render and present, on the display of the electronic device, the contact information corresponding to at least one of the one or more second electronic devices whose user is determined to be currently available.

5. The electronic device of claim 1, wherein to render and present emergency information on the display of the electronic device, the at least one processor is further configured to cause the electronic device to render and present, on the display of the electronic device, a medical information e-card comprising at least one of a name, a blood type, a medication list, an allergy list, and a medical condition list.

6. The electronic device of claim 1, wherein the at least one processor is further configured to cause the electronic device to:
in response to determining that a distance between the electronic device and a medical facility is less than a predetermined distance, render and present, on the display of the electronic device, a health insurance e-card comprising at least one of an account holder name, an insurance provider, and an account number.

7. The electronic device of claim 1, wherein the communications subsystem enables the electronic device to communicatively connect to an external device that operates as a biometric sensor, and to detect an emergency condition, the at least one processor receives, via the communications subsystem, biometric trigger data correlated to an emergency condition.

8. The electronic device of claim 1, further comprising a biometric sensor communicatively coupled to the at least one processor, and to detect an emergency condition, the at least one processor receives biometric data from the biometric sensor that is pre-established as trigger data corresponding to one emergency condition.

9. The electronic device of claim 1, wherein the communications subsystem enables the electronic device to communicatively connect to an in-vehicle computer, and to detect an emergency condition, the at least one processor receives an accident indication from the in-vehicle computer via the communications subsystem.

10. A method comprising:
detecting, on an electronic device comprising a display, an emergency condition based on received trigger data; and
in response to detecting the emergency condition:
accessing emergency information that is securely stored on the electronic device; and
rendering and presenting the emergency information on the display of the electronic device.

11. The method of claim 10, further comprising:
identifying contact information associated with one or more second electronic devices, wherein the one or more second electronic devices are associated with a designated emergency contact record stored within the electronic device; and
rendering and presenting, on the display of the electronic device, the contact information corresponding to at least one of the one or more second electronic devices.

12. The method of claim 11, further comprising:
determining a distance between the electronic device and each of the at least one second electronic devices;
sorting the contact information corresponding to each of the one or more second electronic devices based on the corresponding determined distance; and
selectively rendering and presenting, on the display of the electronic device, the contact information corresponding to at least one of the one or more second electronic devices that is closest in distance to a location of the electronic device.

13. The method of claim 11, further comprising:
determining an availability status of a respective user of each of the one or more second electronic devices;
sorting the contact information corresponding to each of the one or more second electronic devices based on the corresponding determined availability status of the respective user; and
selectively rendering and presenting, on the display of the electronic device, the contact information corresponding to at least one of the one or more second electronic devices whose user is determined to be currently available.

14. The method of claim 10, wherein rendering and presenting the emergency information on the display of the electronic device further comprises displaying a medical information e-card comprising at least one of a name, a blood type, a medication list, an allergy list, and a medical condition list.

15. The method of claim 10, further comprising:
in response to determining that a distance between the electronic device and a medical facility is less than a predetermined distance, rendering and presenting, on the display of the electronic device, a health insurance e-card comprising at least one of an account holder name, an insurance provider, and an account number.

16. The method of claim 10, wherein detecting the emergency condition comprises receiving biometric data from a biometric sensor within the electronic device that is pre-established as trigger data corresponding to one emergency condition.

17. The method of claim 10, wherein detecting the emergency condition comprises receiving biometric data from a biometric sensor external to the electronic device that is pre-established as trigger data corresponding to one emergency condition.

18. The method of claim 10, wherein detecting the emergency condition comprises receiving an accident indication from an in-vehicle computer.

19. A computer program product comprising a non-transitory computer readable medium having program instructions that when executed by a processor of an electronic device comprising a display, configure the electronic device to perform functions comprising:
detecting an emergency condition based on trigger data received by the processor; and
in response to detecting the emergency condition:
accessing emergency information that is securely stored on the electronic device; and
rendering and presenting the emergency information on the display of the electronic device.

20. The computer program product of claim 19, further comprising program instructions for:
identifying contact information associated with one or more second electronic devices, wherein the one or more second electronic devices are associated with a designated emergency contact record stored within the electronic device; and
rendering and presenting, on the display of the electronic device, the contact information corresponding to at least one of the one or more second electronic devices.
